(19) United States
(12) Patent Application Publication
(10) Pub. No.: US 2015/0197421 A1
(43) Pub. Date: Jul. 16, 2015

(54) NANO PT-CE OXIDE CATALYST FOR ACTIVATION OF METHANE AND A PROCESS FOR THE PREPARATION THEREOF

(71) Applicant: Council of Scientific and Industrial Research, New Delhi (IN)

(72) Inventors: Bal Rajaram, Mohkampur (IN); Singha Rajib Kumar, Mohkampur (IN); Sarkar Bipul, Mohkampur (IN); Pendem Chandrashekar, Mohkampur (IN); Shankha Shubhra Acharyya, Mohkampur (IN); Ghosh Shilpi, Mohkampur (IN); Bordoloi Ankur, Mohkampur (IN); Konathala Laxmi Narayan Sivakumar, Mohkampur (IN)

(21) Appl. No.: 14/592,392

(22) Filed: Jan. 8, 2015

(30) Foreign Application Priority Data
Jan. 13, 2014 (IN) 87/DEL/2014

(51) Int. Cl. C01B 3/40; B01J 23/63

(52) U.S. Cl. CPC C01B 3/40; B01J 23/63; C01B 2203/0261; C01B 2203/107; C01B 2203/1241

(57) ABSTRACT

The present invention provides a process and a catalyst for the production of synthesis gas (a mixture of CO and H₂) by partial oxidation of methane. The process provides a direct single step selective vapor phase partial oxidation of methane to synthesis gas over Pt—CeO₂ catalyst between temperature range of 350° C. to 800° C. at atmospheric pressure. The process provides a methane conversion of 28-95% with H₂ to CO mole ratio of 1.6 to 2.

### CLAIM OF PRIORITY

This application claims the benefit of priority of India Patent Application No. 87/DEL/2014, filed on Jan. 13, 2014, the benefit of priority of which is claimed hereby, and which is incorporated by reference herein in its entirety.

### FIELD OF INVENTION

The present invention relates to a Nano Pt—Ce oxide catalyst for activation of methane and a process for the preparation thereof. Particularly, the present invention relates to a process for the activation of methane at low temperature for the production of syngas using Nano Pt—Ce oxide catalyst. More particularly, the present invention relates to a process for the partial oxidation of methane to syngas with H₂ to CO molar ratio of 1.6 to 2 at atmospheric pressure over Pt—CeO₂ solid catalysts.

### BACKGROUND OF THE INVENTION

Methane, the most abundant and predominant component of the natural gas is forecasted to outlast oil within 60 years. Therefore, most of the recent studies are concentrated on the utilization of methane by its activation because of its plentiful abundance in many locations around the globe. Now methane, one of the most abundant and available natural gas can be utilized for the purpose to produce fuel. The current mean projection of remaining recoverable resources of natural gas is 16,200 Trillion cubic feet (Tcf), 150 times than the current annual global gas consumption. But methane may also contain some amount of impurity of higher hydrocarbons like ethane, propane and some other gasses like hydrogen sulfide, carbon dioxide, nitrogen etc. In recent time the use of natural gas as a feedstock to synthesize chemicals or fuels is uneconomical because of the costly storage process and transportation system from the remote areas of the globe where it is mostly available. Particularly in recent years, methods to enhance the value addition of the natural gas methane have been investigated either by synthesizing more valuable chemicals or more easily transportable fuels. But the yields are found to be too low as the desired products are more reactive than methane itself and is unable to compete with the oil. Oxidative methane coupling to ethane gives maximum achievable amount of yield around 30% because there is an inherent limit and since an important part of the reaction goes through gas phase reaction kinetics. Another process is continuous direct conversion of methane to methanol or formaldehyde and the maximum yields so far achieved is 8% and 4% respectively. Recently >50% of methanol yield has been reported in a batch process but it is not an ideal process because of the use of sulfuric acid and mercury which produces unwanted sulfur dioxide as byproduct, which need to be converted back to sulfuric acid for industrial use. Industrial processes for the production of hydrogen cyanide by the reaction of methane and ammonia or ammonia, oxygen and ethylene by pyrolysis are available but both the processes have their drawbacks due to the high temperature requirement at about more than 1027° C. Therefore, at this time the most useful economical path to utilize methane is by the production of more valuable chemicals through syngas generation. Now several synthesis gas production processes are available based on the purpose of industrial applications. Synthesis gas can be produced by steam reforming of methane, CO₂ reforming of methane, partial oxidation of methane and decomposition of methanol (mainly used in hydrogen production in fuel cells because methanol is high in energy density and easy to transport). Industrially methanol is synthesized from syngas, generated from coal or natural gas. Till date steam reforming is the only large scale syngas production process. Steam reforming is highly endothermic and the current industrial catalysts are used in Nickel based. However nickel promotes carbon formation which deactivates the catalyst and reactor plugging. But the desirable H₂/CO ratio of 2 (two) for the downstream application is lower than the produced H₂/CO ratio of steam reforming; therefore an alternative process can be applied such as partial oxidation of methane where the H₂/CO ratio of 2 (two), which is perfect for the downstream processes, particularly for methanol synthesis and Fischer-Tropsch process.

Partial oxidation of methane is likely to become more important in the recent future of methane conversion due to its thermodynamic advantages over steam reforming.

(1) Partial oxidation of methane is mildly exothermic while steam reforming is highly endothermic. So partial oxidation is more economical to heat and it can also be combined with other endothermic processes, such as steam reforming or dry reforming of methane to make this process more energy efficient.
(2) The H₂/CO ratio produced in stoichiometric partial oxidation is around 2 which are perfect for the industrial downstream processes, in particular for methanol synthesis and Fischer-Tropsch process.
(3) The products obtained from partial oxidation can be very low in carbon dioxide content, which must be removed before synthesis gas can be used in downstream process.
(4) Partial oxidation of methane avoids the need for large amount of superheated steam which is required in steam reforming.

The papers detailing the catalytic partial oxidation of methane to synthesis gas shows that high yields of synthesis gas were only obtained above 850° C., below this temperature non equilibrium product distribution is obtained. Studies revealed that lanthanide oxide supported ruthenium catalyst had excellent activity for the partial oxidation of methane and there is no carbon formation, and it was confirmed by high resolution electron microscopy. This result prompted other research groups for a detailed investigation of stoichiometric partial oxidation of methane over noble metals and other metals also. Thermodynamic calculations shows that higher temperature is favorable for partial oxidation of methane and H₂, CO selectivity where high pressure is unfavorable for the process and H₂, CO selectivity. The conventional supported nickel catalyst used for methane reforming are very active for carbon formation leads to rapid deactivation of catalyst, While coke-resistance alternatives (Rh, Ru, Pt etc.) are excellent but bounded by their availability and high cost.

Reference may be made to article in Applied Catalysis A: General 223 (2002) 253-260 by Piboon Pantu, George R. Gavalas, where they reports Pt catalyst supported on CeO₂ for partial oxidation of methane. At optimized condition with 0.5% Pt supported on CeO₂ and Al₂O₃ shows 53% and 39% CH4 conversion at 600° C. using diluted feed CH₄:O₂=1.8-2, He:CH₄=8.5.

Reference may be made to article in the Catalysis Today 180 (2012) 111-116 by Carla E. Hori et al. where they reported the Pt catalyst supported on the basis CeZrO₂/Al₂O₃ catalyst for partial oxidation of methane. At optimized condition with CH₄/O₂ ratio of 2:1 and Pt/10% Ce ZrO₂/Al₂O₃ shows below 70% methane conversion at 800° C. with a GHSV of 170 h⁻ but catalyst deactivates after 24 h.

Reference may be made to article in the Journal of Catalysis 276 (2010) 351-359 by D. Zanchet, J. M. C. Bueno and his group, where they have reported partial oxidation of methane over Pt nanoparticles supported on CeO₂—Al₂O₃ catalyst with 2:1:1 of CH₄/O₂/N₂ ratio at 800° C. With 0.3 and 0.6 wt % Pt showed similar conversion of ≦60%.

Reference may be made to article in the Journal of Catalysis 273 (2010) 125-137 by Horia Metiu and his group reported partial oxidation of methane over Pt nanoparticles supported on CeO₂ at 800° C. with 98% methane conversion and 48% CO, 61% H₂ selectivity using 1:1 O₂/CH₄ ratio. Reference may be made to U.S. Pat. No. 6,254,807B1 by Schmidt et al. on “control of H₂ and CO production in partial oxidation process” where they use at least one transition metal (preferably Ni) monolith catalyst under partial oxidation condition. In optimized condition with monolith catalyst of 50% porosity with GHSV between 60000 to 3000000 h⁻¹ to achieve a methane conversion of 70% with Ni as a catalyst where it goes to 80% with Rh catalyst. But the catalyst deactivates after 40 h.

Reference may be made to U.S. Pat. No. 6,402,989B1 by A. M. Galgney, where his invention relates to a catalyst and process using promoted (at least one from the group consisting Mn, Mo, W, Sn, Re, Bi, In, P etc.) nickel based catalyst supported on MgO. The catalyst contain 1 to 50 wt % of Ni with 0.1 to 10 w % of one promoted where with Mn promoted Ni catalyst shows 100% conversion of methane at 100000 GHSV ml h⁻¹ g⁻¹ at 730° C. at a pressure about 850 to 3000 kPa. But the main drawback of the process is the requirement of very high pressure with high temperature and this condition may leads to phase sintering of the catalyst.

Reference may also be made to article in the Applied Catalysis A: General 335 (2008) 145-152 in which F.B. Noronha et al. reported synthesis gas production in a quartz tube reactor using methane and oxygen mixture at 2:1 ratio at 800° C. and atmospheric pressure over Pt—CeO₂/Al₂O₃ catalyst. Methane conversion was reported ˜75% at WHSV=522 h⁻¹.

Reference may be made to article in the Applied Catalysis A: General 243 (2003) 135-146 by Lidia Pino and his group reported to carry partial oxidation of methane at a temperature of 800° C. using 1% Pt—CeO₂. In reaction with the O₂, methane conversion is around 95-96% with the H₂ selectivity of in the range of 94-99%, with catalyst showing high stability for 100 hrs. But the main drawback of the report is it was reported at very high temperature at 800° C.

The drawback of the processes reported so far is that although they exhibit sufficiently high conversions of methane for high selectivity of syngas of H₂/CO ratio almost 2 but the temperature reported for those results are very high at around 800° C. To overcome the high energy activation of methane researchers tried to make new catalysts using lower transition metals like Ni to noble metals like Pt, Ru etc. The authors did not report about the conversion and selectivity at low temperatures.

### OBJECTS OF THE INVENTION

The main object of the present invention is to provide Nano Pt—Ce oxide catalyst for activation of methane and a process for the preparation thereof.

Another objective of the present invention is to provide a process for activation of methane to syngas at low temperature over Nano Pt—Ce oxide catalyst using oxygen as an oxidant.

Still another object of the present invention is to provide a process, which selectively gives syngas from methane with H₂/Co mole ratio between 1.6 to 2.

Yet another object of the present invention is to provide a process which uses most abundant natural gas having the potential to become the main source for the future fuel alternatives to produce synthesis gas, which is the main composition for the production of hydrocarbon by means of Fischer-Tropsch process.

Yet another object of the present invention is to provide a process which works under continuous process at atmospheric pressure for the production of synthesis gas from methane.

Yet another object of the present invention is to provide a catalyst with a mixture of Pt and Ce oxide which can be prepared easily and also very economical to produce syngas by partial oxidation of methane.

### SUMMARY OF THE INVENTION

Accordingly, the present invention provides a Nano Pt—Ce oxide catalyst having formula PtO—CeO₂ comprises PtO in the range of 1-4 wt % and CeO₂ in the range 99-96 wt % wherein 1-2 nm Pt nanoparticles are present on 20-30 nm CeO₂ nanoparticles.

In one embodiment of the present invention, a process for the preparation of Nano Pt—Ce oxide catalyst, wherein the said process comprises the steps of:
a) stirring Ce salt, a surfactant and H₂O for a period ranging between 2-3 hrs at a temperature ranging between 25-35° C. followed by adding ammonia solution to adjust the pH in the range of 8-10 and further stirring for a period ranging between 3-4 hrs at a temperature ranging between 25-35° C. followed by heating the mixture in an autoclave at a temperature ranging between 170° C. to 180° C. for a time period ranging between 8-10 days to obtain a precipitate;
b) filtering the precipitate as obtained in step (a) with water and dried at temperature ranging between 60° C.-110° C. for a time period ranging between 15-20 hrs followed by calcining the dried product at a temperature in the range of 400-750° C. for a time period in the range of 4-10 hours to obtain Ce oxide (CeO₂);
c) adding dropwise [Pt(NH₃)₄(NO₃)₂] solution in water to the ethanolic solution of cetyltrimethylammonium bromide and stirring the solution for a period ranging between 15-30 mins at a temperature ranging between 25-35° C. to obtain Pt salt solution; and
d) adding Pt salt solution as obtained in step (c) with CeO₂ as obtained in step (b) in ethanol followed by adding hydrazine to adjust pH in the range of 8-9 followed by stirring the mixing for a period ranging between 2-3 hrs at a temperature ranging between 25-35° C. followed by drying at a temperature ranging between 60-90° C. for a period ranging between 15-20 hrs followed by calcining at a temperature ranging between 450-700° C. for a time period ranging between 3-10 hrs to obtain Nano Pt—Ce oxide catalyst.

In one embodiment of the present invention, the Ce salt used in step (a) is cerium nitrate hexahydrate.

In an embodiment of the present invention, the surfactant used in step (a) is Poly(diallyldimethyl)ammonium chloride.

In another embodiment of the present invention, wt % ratio of Pt and Ce is in the range of 1:99-3:97.

In another embodiment of the present invention, a process for activation of methane using Pt—CeO₂ catalyst to obtain syngas, wherein the said process comprises passing O₂:CH₄:He mixture with a molar ratio of 1:2:2 to 1:2:7 in a reactor at atmospheric pressure in the presence of Nano Pt—Ce oxide catalyst at a temperature ranging between 350-800° C. for a period ranging between 1-80 hrs at a gas hourly space velocity (GSHV) ranging between 5000-500000 mlg-1h-1 to obtain syngas.

Still in another embodiment of the present invention, the activation of methane is done at 350° C.

Still in another embodiment of the present invention, the conversion of methane is in the range of 1-97%.

Still in another embodiment of the present invention, the H₂/CO ratio of syngas obtained in the range of 1.6-2.0.

### BRIEF DESCRIPTION OF DRAWINGS

FIG. 1: X-ray Diffraction (XRD) of 1% Pt—CeO₂:

FIG. 2: Scanning Electron Microscope (SEM) image of 1% Pt—CeO₂

FIG. 3: Low magnification Transmission Electron Microscope (TEM) image of 1% Pt—CeO₂

FIG. 4: High magnification TEM image of 1% Pt—CeO₂

FIG. 5: Mapping of Ce in 1% Pt—CeO₂

FIG. 6: Mapping of Pt in 1% Pt—CeO₂

FIG. 7: X-ray Diffraction (XRD) of 3% Pt—CeO₂:

FIG. 8: SEM image of 3% Pt—CeO₂

FIG. 9: Low magnification TEM image of 3% Pt—CeO₂

FIG. 10: High magnification TEM image of 3% Pt—CeO₂

FIG. 11: Mapping of Ce in 3% Pt—CeO₂

FIG. 12: Mapping of Pt in 3% Pt—CeO₂

### DETAILED DESCRIPTION OF THE INVENTION

The present invention provides a process for the preparation of Nano Pt—Ce oxide to produce a synthesis gas by partial oxidation of methane involving the following steps.

The process for the preparation of Pt—CeO₂ oxide catalyst comprising the steps of:

synthesis of CeO₂ oxide was carried out using gel composition of Ce(NO₃)₃.6H₂O, Poly(diallyldimethylammonium chloride) solution (PDADMAC), 25% NH₃ solution where Ce(NO₃)₃.6H₂O was used as the precursor of Ce.

The molar ratio of Ce to PDADMAC varied in the range of 8000-12000.

The pH of the gel was adjusted between 8-10.

The molar ratio of H₂O to Ce varied in the range of 20-30.

The mixing gel was stirred for 2-6 h at room temperature.

Heating of the resultant solution was carried out in a closed autoclave at 180° C. for 8-10 days.

The product was filterer with excess water and dried in an oven with a temperature range of 100-120° C. for 3-24 h. The dried product was calcined in a furnace in a temperature range of 400-750° C. for 3-10 h.

### Loading of Pt on CeO₂:

Pt was incorporated with the above prepared CeO₂ using the following preparation method.

[Pt(NH₃)₄](NO₃)₂ dissolved in water-ethanol medium and were added dropwise to the solution of cetyltrimethylammonium bromide dissolve in ethanol. This solution was added with the solution containing measured amount of previously prepared CeO₂ added with ethanol and stirred. The pH of the solution was adjusted by adding hydrazine solution to it.

The mixture was stirred for 1-3 h at 40° C.

The solution was dried at 60° C.-90° C. by gradual increase in temperature for 6-12 h.

The wt. % of Pt supported on nano crystalline CeO₂ varied in the range between 1 to 4.

Calcination of the materials was done in the temperature range of 450-750° C. for 3-6 h.

### General Procedure for the Partial Oxidation of Methane to Synthesis Gas

The partial oxidation of methane was carried out in a fixed-bed down flow reactor at atmospheric pressure. Typically 10 to 500 mg of catalyst was placed in between two quartz wool plugged in the center of the 6 mm quartz reactor. The reaction was carried out with the freshly prepared catalyst at different temperatures ranging 350-800° C. The gas hourly space velocity (GHSV) was varied between 5000 to 500000 ml g⁻¹ h⁻¹ with a molar ratio of O₂:CH₄:He of 1:2:2 to 1:2:7. The reaction products were analyzed using an online gas chromatography (Agilent 7890A) fitted with a TCD detector using two different columns Molecular sieves (for analyzing H₂) and PoraPack-Q (for analyzing CH₄, CO₂ and CO).

The following examples are given by way of illustration of working of the invention in actual practice and should not be constructed to limit the scope of the present invention in any way.

### Example-1

### Preparation of CeO₂

1.23 gm of LMW-PDADMAC (low molecular weight, M_{W}=100000-200000, Poly(diallyldimethylammoniumchloride) was taken in a beaker. 25 ml of water was added into it further stirred the solution for 15 min at temperature 30° C. to get a clear solution. 21.52 gm of cerium nitrate hexahydrate solution in water was added in to it followed by continued stirring for 2 hrs. pH of the solution was maintained to 8 using 30% NH₃ solution. The whole mixture was continued stirring for 3.5 hrs at temperature 30° C. After that the total mixture was kept into an autoclave for 10 days at 180° C. After 10 days, the precipitate was washed with water and then with ethanol. The precipitate was dried at 110° C. overnight for 15 hrs. Then the material was calcined at 550° C. for 6 hrs.

### Preparation of 1% Pt—CeO2

### Preparation of Pt-Salt Solution

0.021 gm CTAB (Cetyltrimethylammonium bromide) was dissolved in 5 ml ethanol and stirred for 15 minutes to get a clear solution. Then 0.023 gm Tetraamine platinum(II)nitrate dissolved in 15 ml water was added with the CTAB solution and stirred for 30 minutes at temperature 30° C.

### Preparation of 1% Pt—CeO₂

1 gm previously prepared CeO₂ was taken in a beaker and added 30 ml ethanol. The mixture was stirred for 30 minutes at a temperature 30° C. Then Pt-salt solution (20 ml) was added dropwise to the mixture and the stirring was continued for 30 minutes. Then hydrazine hydrate amount, 300 μL was added to maintain the pH of the solution to 8. The whole mixture was stirring for 2 hrs at room temperature (30° C.) and the mixture was evaporated to dryness at 90° C. by gradual increase in temperature. Then it was dried at 120° C. for 6 h and calcined at 550° C. for 7 h.

The materials were characterized by XRD, SEM, elemental mapping and TEM.

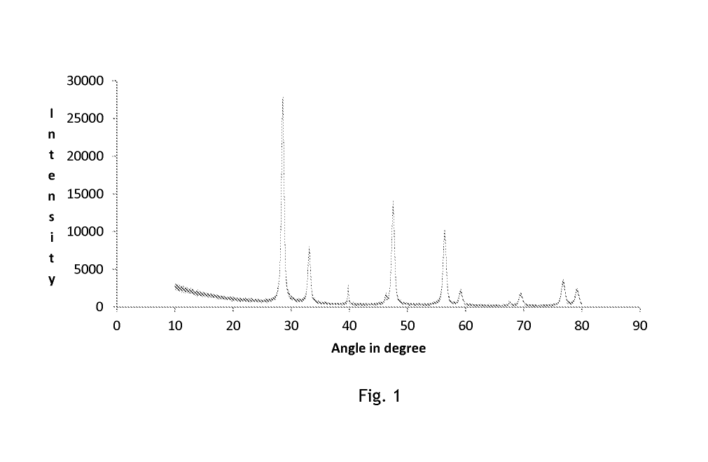

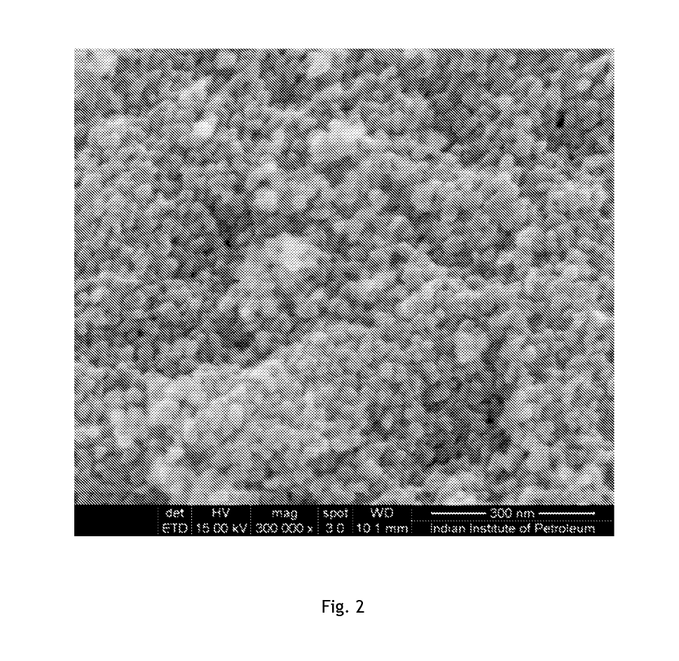

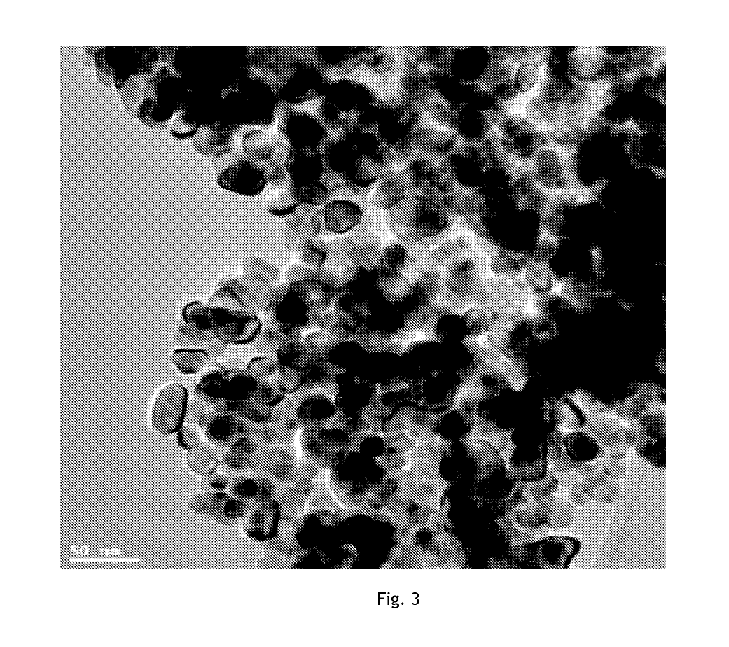

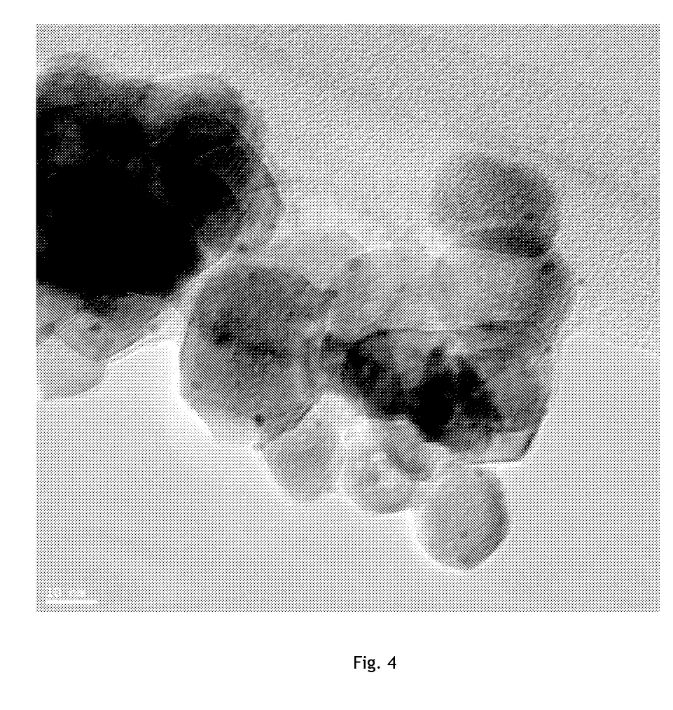

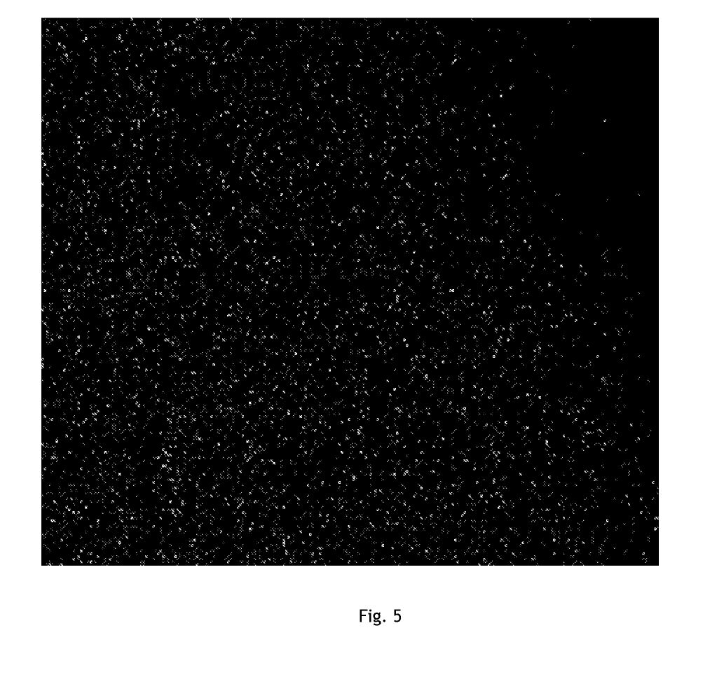

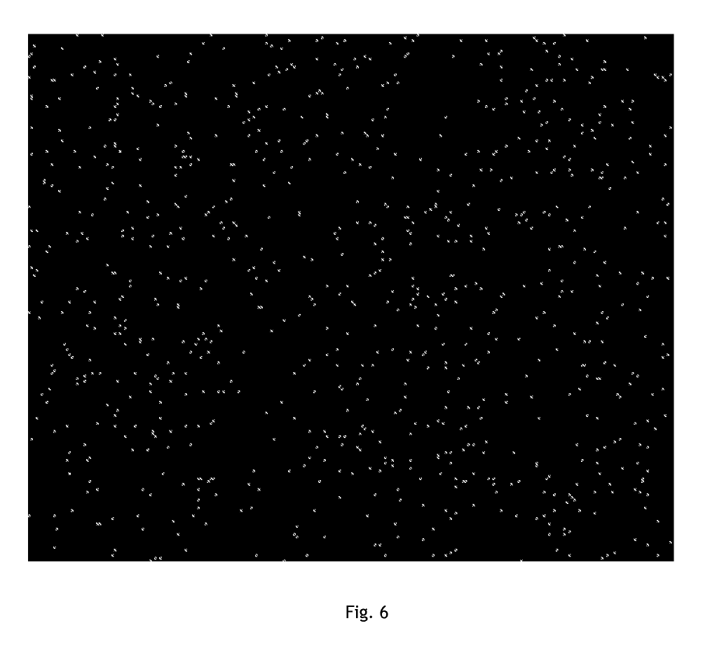

The XRD pattern of the 1% Pt—CeO₂ is shown in FIG. 1. XRD depicts the presence of Pt-oxide and CeO₂ in the sample. The morphology of the material (1% Pt—CeO₂) was characterized by SEM. The typical image of the 1% Pt—CeO₂ is shown in FIG. 2. From the SEM image it is clear that the particles are almost spherical in shape. The typical TEM images of the 1% Pt—CeO₂ are shown in FIG. 3-4, which indicate that 1-2 nm Pt nanoparticles are present on 20-30 nm Ce02 nanoparticles. FIG. 3 is the TEM images at low magnification and FIG. 4 is the image of the 1% Pt—CeO₂ at very high magnification. The dispersion of the Pt particles on CeO₂ support was analyzed by taking the elemental mapping of Pt and Ce using SEM as shown in FIG. 5 and FIG. 6. The mapping confirms that Pt is highly dispersed on CeO₂.

### Example-2

### Preparation of CeO₂

0.83 gm of LMW-PDADMAC (low molecular weight, M_{W}=100000-200000, Poly(diallyldimethylammoniumchloride) was taken in a beaker. Added 25 ml of water in it. Stirred for 15 min at temperature 30° C. to get a clear solution. Added 21.47 gm of cerium nitrate hexahydrate solution in water into the solution. Continued stirring for 2 hrs at a temperature 30° C. pH of the solution was maintained to 8 using 30% NH₃ solution. The whole mixture was continued stirring for 3.5 hrs. After that the total mixture was kept into an autoclave for 10 days at 180° C. After 10 days, the precipitate was washed with water and then ethanol. The precipitate was dried at 60° C. overnight for 15 hrs. Then the material was calcined at 550° C. for 5 hrs.

### Preparation of 3% Pt—CeO₂

### Preparation of Pt-Salt Solution

0.0572 gm CTAB(Cetyltrimethylammonium bromide) was taken in a beaker. Added 5 ml of ethanol. Stirred for 15 minutes to dissolve CTAB. Added 5 ml of water to the mixture. Then added 0.0612 gm of Tetraamine platinum(II)nitrate salt and stirred for 15 minute at 30° C. to get a clear solution.

### Preparation of 3% Pt—CeO2

1 gm previously prepared CeO₂ was taken in a beaker and added 30 ml ethanol. The mixture was stirred for 30 minutes at temperature 30° C. The Pt-salt solution (10 ml) was then added dropwise to the mixture. Continued stirring for 30 minutes. Then added hydrazine hydrate (1 ml) to maintain the pH of the solution to 8. The whole mixture was continued stirring for 2 hrs at room temperature (30° C.). Then the mixture was evaporated to dryness at 90° C. by gradual increasing of temperature. Then it was dried at 120° C. for 6 h and calcined at 550° C. for 6 hrs. The materials were characterized by XRD, SEM, elemental mapping and TEM.

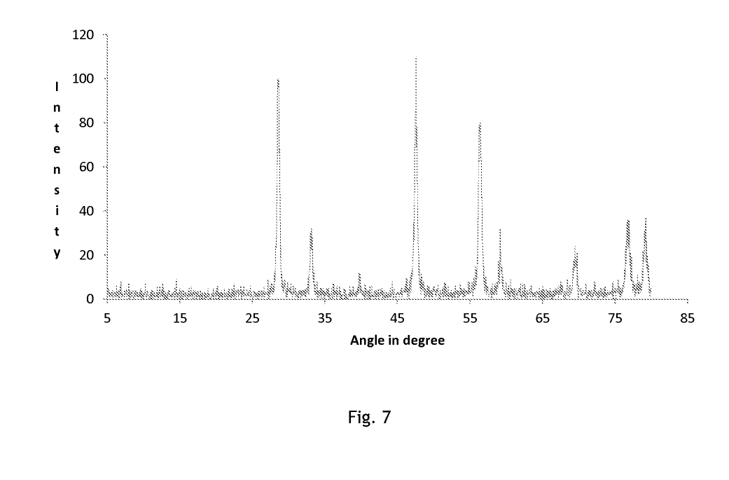

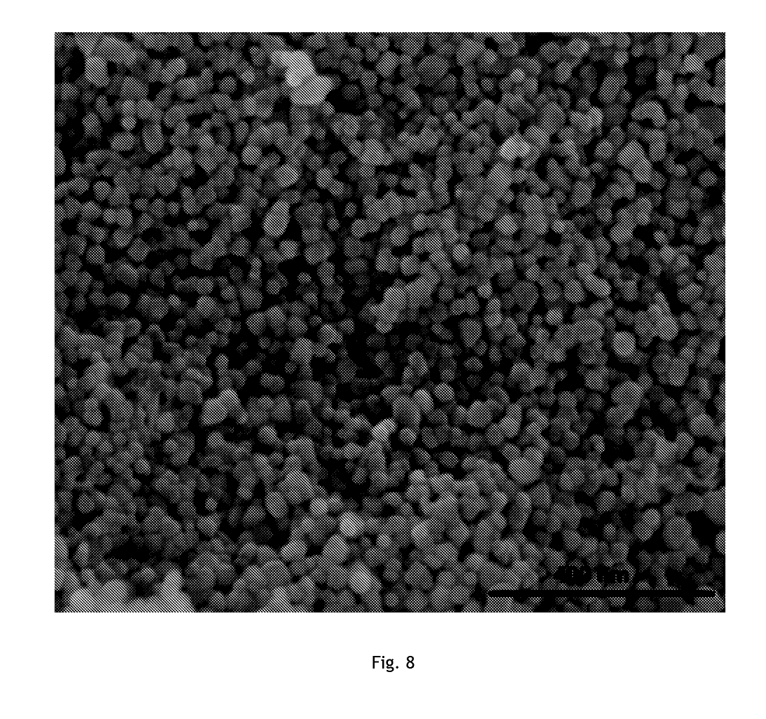

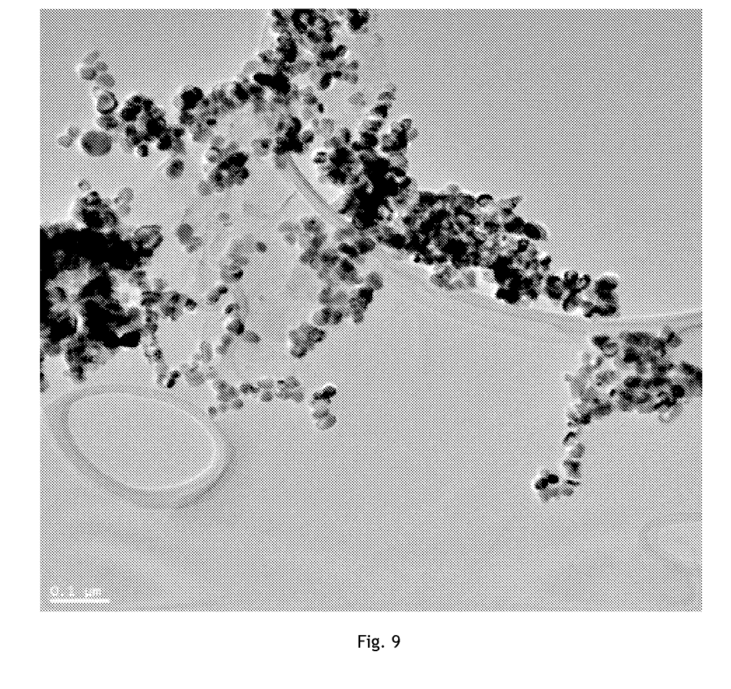

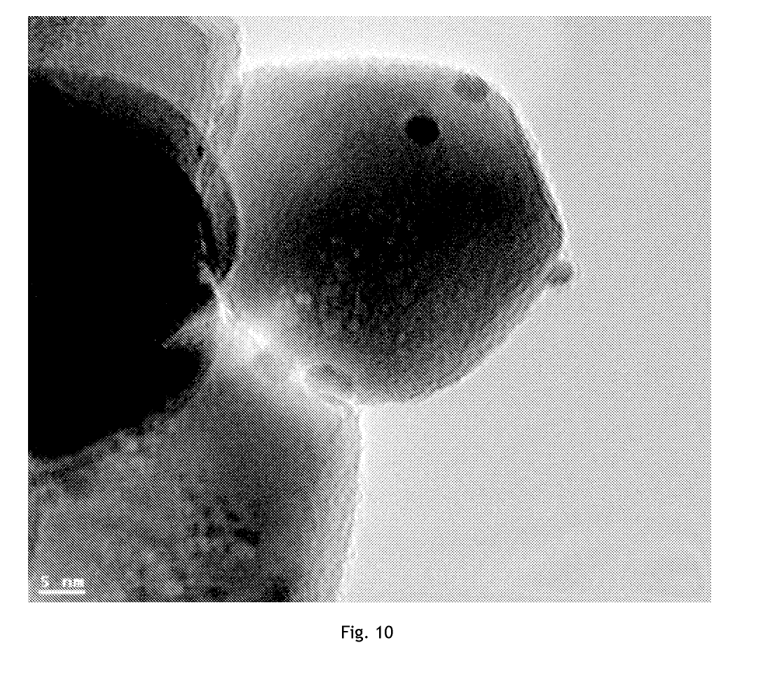

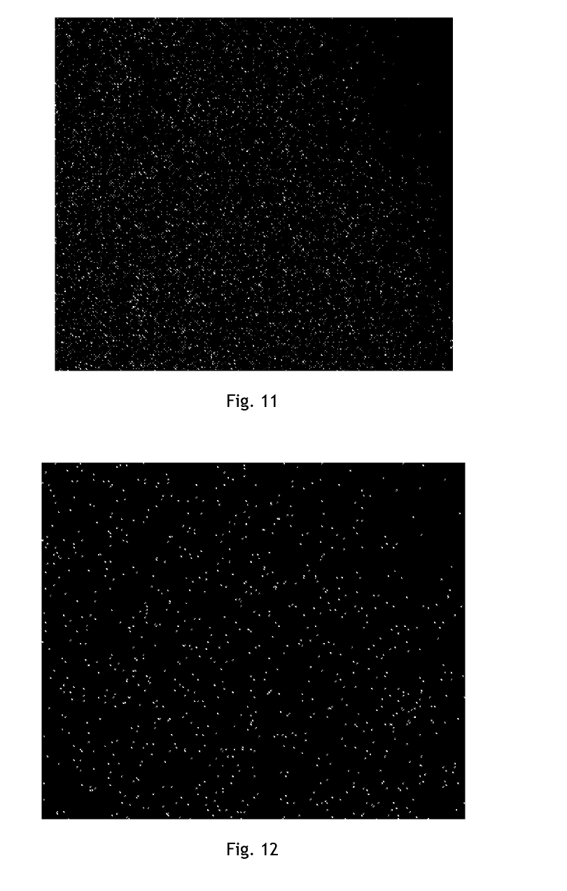

The XRD pattern of the 1% Pt—CeO₂ are shown in FIG. 7. XRD depicts the presence of Pt-oxide and CeO₂ in the sample. The morphology of the material (1% Pt—CeO₂) was characterized by SEM. The typical image of the 1% Pt—CeO₂ is shown in FIG. 8. From the SEM image, it is clear that the particles are almost spherical in shape. The typical TEM images of the 3% Pt—CeO₂ are shown in FIG. 9-10, which indicate that 1-2 nm Pt nanoparticles are present on 20-30 nm CeO₂ nanoparticles. FIG. 9 is the TEM images at low magnification and FIG. 10 is the image of the 3% Pt—CeO₂ at very high magnification. The dispersion of the Pt particles on CeO₂ support was analyzed by taking the elemental mapping of Pt and Ce using SEM as shown in FIG. 11 and FIG. 12. The mapping confirms that Pt is highly dispersed on CeO₂.

### Example-3

The example describes the effect of temperature on conversion and H₂/CO ratio of partial oxidation of methane. The product analysis presented in Table-1.

### Process Conditions:

### Catalyst: 0.12 g

Pt: CeO₂ weight ratio in the catalyst=2:98.
Process pressure: 1 atm.
Gas hourly space velocity (GHSV): 50000 ml g⁻¹ h⁻¹
Reaction time: 8 h

### O₂: CH₄: He=1:2:7 (mol %)

TABLE 1
Effect of temperature on conversion of methane and H₂/CO
ratio of partial oxidation of methane

| Temperature | Methane | | Syngas |
|---|---|---|---|
| (° C.) | Conversion (%) | CO Selectivity (%) | H₂/CO ratio |
| 350 | 28.00 | 73 | 1.6 |
| 400 | 30.97 | 78 | 1.7 |
| 500 | 41.24 | 81 | 1.7 |
| 550 | 48.40 | 86 | 1.8 |
| 600 | 56.69 | 94 | 1.8 |
| 700 | 73.39 | 96 | 1.9 |
| 800 | 96.63 | 98 | 1.9 |

### Example-4

The example describes the effect of gas hourly space velocity on the conversion of methane and H₂/CO ratio of partial oxidation of methane. The product analysis presented in Table-3.

### Process Conditions:

### Catalyst: 0.12 g

Pt:CeO₂ weight ratio in the catalyst=2:98.
Process pressure: 1 atm

### Temperature: 400° C.

Reaction time: 8 h

### O₂: CH₄: He=1:2:7 (mol %)

TABLE 2
Effect of gas hourly space velocity (GHSV) on the conversion of
methane and H₂/CO ratio of partial oxidation of methane

| GHSV | Methane | CO Selectivity | H₂/CO ratio |
|---|---|---|---|
| (ml feed/h/g_{cat}) | Conversion (%) | (%) | (Syngas) |
| 5000 | 31.12 | 67 | 1.6 |
| 10000 | 30.24 | 68 | 1.6 |
| 20000 | 30.92 | 70 | 1.6 |
| 50000 | 30.97 | 73 | 1.6 |
| 100000 | 35.82 | 74 | 1.6 |
| 300000 | 29.17 | 74 | 1.6 |
| 500000 | 27.34 | 74 | 1.6 |

### Example-5

The example describes the effect of gas hourly space velocity on the conversion of methane and H₂/CO ratio of partial oxidation of methane at 800° C. The product analysis presented in Table 3.

### Process Conditions:

### Catalyst: 0.12 g

Pt:CeO₂ weight ratio in the catalyst=2:98.
Process pressure: 1 atm

### Temperature: 800° C.

Reaction time: 8 h

### O₂: CH₄: He=1:2:7 (mol %)

TABLE 3
Effect of gas hourly space velocity (GHSV) on the conversion
of methane and H₂/CO ratio of partial oxidation of methane

| GHSV | Methane | | H₂/CO ratio |
|---|---|---|---|
| (ml feed/h/g_{cat}) | Conversion (%) | CO Selectivity (%) | (Syngas) |
| 5000 | 98.2 | 91 | 1.8 |
| 10000 | 97.4 | 93 | 1.8 |
| 20000 | 94.1 | 96 | 1.8 |
| 50000 | 91.6 | 98 | 1.9 |
| 100000 | 90.8 | 98 | 1.9 |
| 300000 | 87.3 | 98 | 1.9 |
| 500000 | 85.1 | 98 | 1.9 |

### Example-6

The example describes the effect of time on stream on conversion of methane and H₂/CO ratio of dry reforming of methane. The product analysis presented in Table 4.

Process Conditions:

### Catalyst: 0.12 g

PT: CeO₂ weight ratio in the catalyst=2:98.
Process pressure: 1 atm
Gas hourly space velocity (GHSV): 50000 ml g⁻¹ h⁻¹
Reaction temperature: 400° C.
Methane conversion: 22-26%
O₂: CH₄: He=1:2:7 (mole %)

TABLE 4
Effect of Time on Stream (TOS) on the conversion of methane

| GHSV | Temperature | | Methane |
|---|---|---|---|
| (ml feed/h/g_{cat}) | (° C.) | Time (h) | Conversion (%) |
| | | 0 | 31.31223 |
| | | 1 | 22.48258 |
| 50000 | 400° C. | 2 | 25.85946 |
| | | 4 | 24.72596 |
| | | 5 | 24.79613 |
| | | 6 | 25.46183 |
| | | 7 | 25.01423 |
| | | 8 | 25.46323 |
| | | 10 | 24.8002 |
| | | 15 | 25.64646 |
| | | 20 | 24.49478 |
| | | 25 | 23.96613 |
| | | 30 | 25.99552 |
| | | 35 | 22.55801 |
| | | 40 | 20.18041 |
| | | 50 | 22.49607 |
| | | 60 | 22.1143 |
| | | 80 | 22.00446 |
| | | 95 | 18.18542 |
| | | 100 | 16.97347 |

### Advantages of the Present Invention

The main advantages of the present invention are:
The process of the present invention is to utilize methane by converting methane to syngas through partial oxidation of methane in a single step with a single catalyst.
The process provides not only good conversion but also good H₂/CO ratio of syngas. The process utilizes a major component of abundant natural gas to produce syngas with H₂/CO ratio almost equal to two, which become the major advantage of this process and which can be directly used for the production of methanol and Fischer-Tropsch synthesis.
The process does not produce any major by-products which is also a major advantage of this process.
The catalyst shows no deactivation up to a time period of 80 h on steam at 400° C.
The catalyst is used in very low amounts.

What is claimed is:

1. A Nano Pt—Ce oxide catalyst having formula PtO—CeO₂ comprises PtO in the range of 1-4 wt % and CeO₂ in the range 99-96 wt % wherein 1-2 nm Pt nanoparticles are present on 20-30 nm CeO₂ nanoparticles.

2. A process for the preparation of Nano Pt—Ce oxide catalyst as claimed in claim 1 wherein the said process comprises the steps of:
a) stirring Ce salt, a surfactant and H₂O for a period ranging between 2-3 hrs at a temperature ranging between 25-35° C. followed by adding ammonia solution to adjust the pH in the range of 8-10 and further stirring for a period ranging between 3-4 hrs at a temperature ranging between 25-35° C. followed by heating the mixture in an autoclave at a temperature ranging between 170° C. to 180° C. for a time period ranging between 8-10 days to obtain a precipitate;
b) filtering the precipitate as obtained in step (a) with water and dried at temperature ranging between 60° C.-110° C. for a time period ranging between 15-20 hrs followed by calcining the dried product at a temperature in the range of 400-750° C. for a time period in the range of 4-10 hours to obtain Ce oxide (CeO₂);
c) adding dropwise [Pt(NH₃)₄(NO₃)₂] solution in water to the ethanolic solution of cetyltrimethylammonium bromide and stirring the solution for a period ranging between 15-30 mins at a temperature ranging between 25-35° C. to obtain Pt salt solution; and
d) adding Pt salt solution as obtained in step (c) with CeO₂ as obtained in step (b) in ethanol followed by adding hydrazine to adjust pH in the range of 8-9 followed by stirring the mixing for a period ranging between 2-3 hrs at a temperature ranging between 25-35° C. followed by drying at a temperature ranging between 60-90° C. for a period ranging between 15-20 hrs followed by calcining at a temperature ranging between 450-700° C. for a time period ranging between 3-10 hrs to obtain Nano Pt—Ce oxide catalyst.

3. The process for the preparation of Nano Pt—Ce oxide catalyst as claimed in claim 2, wherein the Ce salt used in step (a) is cerium nitrate hexahydrate.

4. The process for the preparation of Nano Pt—Ce oxide catalyst as claimed in claim 2, wherein the surfactant used in step (a) is Poly(diallyldimethyl)ammonium chloride.

5. The process for the preparation of Nano Pt—Ce oxide catalyst as claimed in claim 2, wherein wt % ratio of Pt and Ce is in the range of 1:99-3:97.

6. A process for activation of methane using Pt—CeO₂ catalyst as claimed in claim 1 to obtain syngas, wherein the said process comprises passing O₂:CH₄:He mixture with a molar ratio of 1:2:2 to 1:2:7 in a reactor at atmospheric pressure in the presence of Nano Pt—Ce oxide catalyst at a temperature ranging between 350-800° C. for a period ranging between 1-80 hrs at a gas hourly space velocity (GSHV) ranging between 5000-500000 mlg⁻¹ h⁻¹ to obtain syngas.

7. The process for activation of methane as claimed in claim 6, wherein the activation of methane is done at 350° C.

8. The process for activation of methane as claimed in claim 6, wherein the conversion of methane is in the range of 1-97%.

9. The process for activation of methane as claimed in claim 6, wherein the H₂/CO ratio of syngas obtained in the range of 1.6-2.0.
